(19) United States
(12) Patent Application Publication
(10) Pub. No.: US 2022/0135082 A1
(43) Pub. Date: May 5, 2022

(54) SYSTEM AND METHOD FOR WIRELESS INTERACTION BETWEEN AN AUTONOMOUS VEHICLE AND A MOBILE DEVICE

(71) Applicant: UNIKEY TECHNOLOGIES INC., Orlando, FL (US)

(72) Inventors: Philip C. Dumas, Orlando, FL (US); E. Patrick Hanavan, III, Winter Springs, FL (US)

(21) Appl. No.: 17/086,881

(22) Filed: Nov. 2, 2020

(51) Int. Cl. B60W 60/00; B60Q 5/00; G08G 1/133; H04W 4/40; H04W 76/10

(52) U.S. Cl. CPC B60W 60/00253; B60Q 5/005; B60W 2556/45; H04W 4/40; H04W 76/10; G08G 1/133

(57) ABSTRACT

A user can request, via an electronic communication, an autonomous vehicle, such as a taxi, using a mobile device. Once the autonomous vehicle arrives at a pickup location, a wireless electronic communication connection is established between the autonomous vehicle and the mobile device. The autonomous vehicle then generates an audible or visual cue to the user. The mobile direct generates a corresponding audible, visual, or tactile cue as directed via the established wireless electronic communication connection. In this way, the user is able to readily identify which autonomous vehicle is the one requested. In further embodiments the mobile device cue duplicates a pattern of the autonomous vehicle cue or the autonomous vehicle cue and the mobile device cue operate in a call and response fashion.

### FIELD OF THE INVENTION

The present disclosure is directed to the field of electronics, and more particularly, to mobile access control and related methods in connection with requesting and identifying an autonomous vehicle.

### BACKGROUND

Autonomous vehicles, such as self-driving cars, trucks, carts, and other delivery devices, may operate with minimal or substantially no human input. For example, a passenger may enter a destination at a console of the autonomous vehicle, such as a touch screen, and the autonomous vehicle may navigate itself to the destination (e.g., a restaurant) by sensing its surrounding environment.

It may be desirable to utilize autonomous vehicles in the transportation and ride share industries. For example, many automotive companies are currently developing autonomous vehicles. An autonomous vehicle, also known as a self-driving vehicle, is a vehicle that can operate on its own without any input from a driver. An autonomous vehicle senses its surroundings and can navigate road conditions using its own set of advanced control systems and components such as RADARs, LIDARs, sensors, Global Positioning System (GPS), and computer vision. These systems and components are implemented in autonomous vehicles to perform all of the various self-driving maneuvers. These advanced control systems interpret input information from numerous sensors to identify appropriate navigation paths and relevant signage, as well as provide for real-time obstacle avoidance. Autonomous vehicles also may come equipped with GPS allowing the vehicle to keep track of its position, even when conditions change, or the autonomous vehicle approaches or enters novel environments.

On-demand transportation companies are also looking to incorporate autonomous vehicles into their fleets to provide short, one-way transportation that can be easily initiated from a user's mobile device (e.g., cell phone, tablet, laptop, smart devices, wearables, etc.). On-demand transportation systems promise to be one of the first test markets for autonomous vehicles; and their success or failure to gain appeal, and importantly, trust from the public may be determinative of how society views autonomous vehicles going forward. Therefore, it is imperative that the user experience while interacting with an autonomous vehicle be as seamless as possible.

Incorporating autonomous vehicles into any on-demand transportation service may cause users some difficulty in identifying or determining whether they are getting into the autonomous vehicle intended for them. Without a driver, the autonomous vehicle removes the normal social authentication between driver and user that each is the user or driver the other was expecting (e.g., by exchanging names, confirming the destination, etc.). Users of an autonomous on-demand transportation service may effectively be on their own regarding finding the correct autonomous vehicle. For example, after a large sporting event several users may contact an on-demand taxi service requesting an autonomous vehicle pick-up. If multiple autonomous taxis arrive at the same time, it may cause a user stress going from one autonomous taxi to another in the hopes that the vehicle they end up in is the correct autonomous taxi going where they want to go.

Thus, there is a need for systems and methods that help users of autonomous on-demand vehicle taxi services to quickly and accurately distinguish an autonomous vehicle that is intended for the user, from other nearby autonomous vehicle on-demand taxis that may be intended for other users.

### SUMMARY OF THE INVENTION

According to some embodiments, a method for wireless interaction between a mobile device and an autonomous vehicle comprising: receiving a request for the autonomous vehicle from a mobile device across an electronic network; establishing an electronic communication connection between the autonomous vehicle and the mobile device once the autonomous vehicle has arrived at an autonomous vehicle pickup location; generating an autonomous vehicle cue by the autonomous vehicle once the electronic communication connection has been established; and, directing the mobile device, via the electronic communication connection, to generate a mobile device cue corresponding to the autonomous vehicle cue.

According to some embodiments, a system for wireless interaction between a mobile device and an autonomous vehicle comprising; a mobile device configured to generate a request for the autonomous vehicle across an electronic network; an autonomous vehicle configured to receive the request for the autonomous vehicle from the mobile device across the electronic network; the autonomous vehicle configured to establish an electronic communication connection between the autonomous vehicle and the mobile device once the autonomous vehicle has arrived at an autonomous vehicle pickup location; the autonomous vehicle configured to generate an autonomous vehicle cue by the autonomous vehicle once the electronic communication connection has been established; the autonomous vehicle configured to direct, via the electronic communication connection, the mobile device to generate a mobile device cue corresponding to the autonomous vehicle cue; and, the mobile device configured to generate the directed mobile device cue.

### BRIEF DESCRIPTION OF THE DRAWINGS

Embodiments of the present approach are described herein with reference to the attached drawings, which are for the purpose of illustrating various embodiments of the present approach and not for the purpose of limitation. In the drawings:

FIG. 1 is a schematic diagram of a system in accordance with one embodiment of the present approach;

FIG. 2 is a flow chart illustrating operation of the system in accordance with one embodiment of the present approach;

FIG. 3 is a flow chart illustrating further operation of the system in accordance with an embodiment of the present approach.

### DETAILED DESCRIPTION

The present approach will now be described more fully hereinafter with reference to the accompanying drawings, in which various embodiments are shown. This present approach may, however, be embodied in many different forms and should not be construed as limited to the embodiments set forth herein. Rather, these embodiments are provided so that this disclosure will be thorough and complete; fully conveying the scope of the present approach to those skilled in the art. Like numbers refer to like elements throughout, and prime notation is used to indicate similar elements or steps in alternative embodiments.

In the present approach, a user can request, via an electronic communication, an autonomous vehicle, such as a taxi, using a mobile device. Once the autonomous vehicle arrives at a pickup location, which can be a specified location such as the user's address or other local predetermined meeting spot or can be a more general pickup area such as one defined by being within a direct wireless communication range of the user or within a defined geofence encompassing the pickup location, a wireless electronic communication connection is established between the autonomous vehicle and the mobile device. The autonomous vehicle then generates an audible or visual cue to the user. The user's mobile device generates a corresponding audible, visual, or tactile cue as directed via the established wireless electronic communication connection. In this way, the user is able to readily identify which autonomous vehicle is the one requested. In further embodiments the mobile device cue duplicates a pattern of the autonomous vehicle cue or the autonomous vehicle cue and the mobile device cue operate in a call and response fashion.

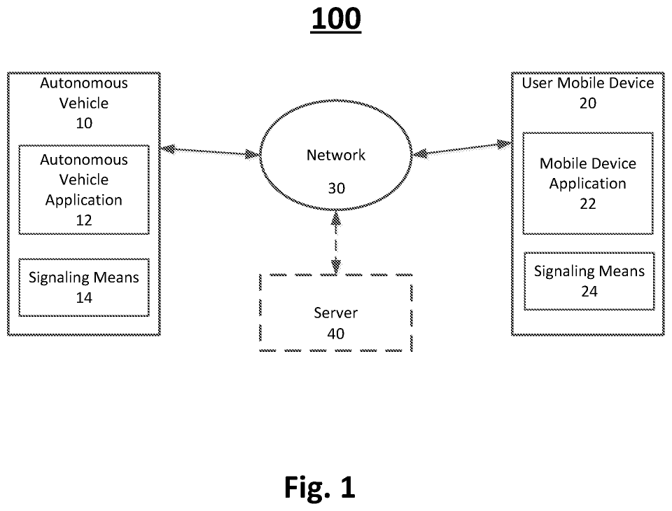

The system of one embodiment of the present approach will now be described with reference to the system diagram of FIG. 1. Shown in the figure is a system 100 for wireless interaction between an autonomous vehicle 10 and a user mobile device 20 via network 30.

As shown, autonomous vehicle 10 comprises autonomous vehicle application 12 and signaling means 14. Similarly, user mobile device 20 comprises mobile device application 22 and signaling means 24.

Optionally, in an alternative embodiment, a server 40 performs some of the processing and or communication functionality described herein as being performed by autonomous vehicle application 12 and/or and by mobile device application 22.

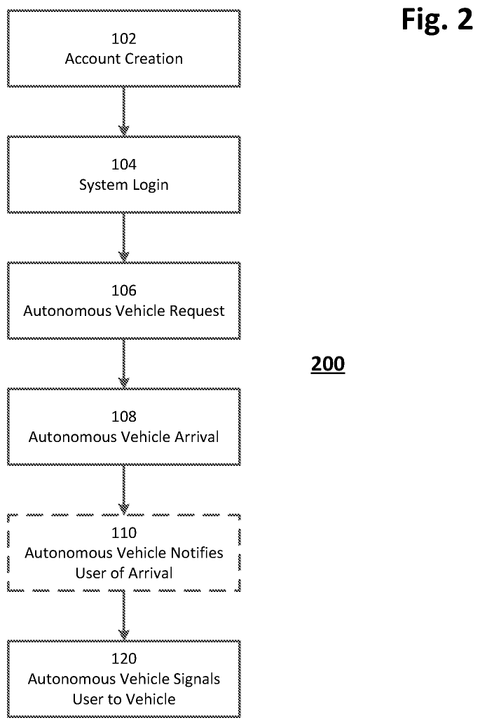

The operation of one embodiment of system 100 will now be described with reference to a process 200 shown in FIG. 2.

In a step 102, a user downloads mobile device application 22 onto user mobile device 20 and is prompted to register a new account on the system. The user is then guided through account creation, providing login details such as a username, password, and an email address. Optionally, the user may also be prompted for personal information, such as a home address, phone number, or birthdate, as well as payment information including credit cards, debit cards, bank wire transfers, digital wallets and other electronic payment services. Once the user has completed step 102 and created a new account, they need not return to this step when using the system going forward.

Once the account has been created, the user can begin at step 104; logging in to the system via the mobile device application 22 on user mobile device 20. The user may provide the username and password associated with their account from step 102. If the credentials correctly match those stored in the system, then the user is provided access to the system, e.g., within server 40, for example, via mobile device application 22 on their mobile device 20. In one non-limiting exemplary embodiment, the system interface provided via mobile device application 22 may include inputs, like the user's current location and destination, as well as buttons for operating the system. These buttons may include, for example, operations like request an autonomous taxi, cancel a previously requested taxi, and account administration.

In step 106, the user may request an autonomous vehicle by selecting ‘request an autonomous taxi’ in the system interface of mobile application 22 on their mobile device 20. The system may prompt the user for the street address of their desired destination, which the user can then type into their mobile device. Other means can be used to specify the user's desired destination including tapping on the location on a map displayed on the user's mobile device, or selecting from a list of predefined or previously specified desired destinations. In addition, the system may include additional user options to choose from such as the size of the autonomous vehicle, the route of the autonomous vehicle, and user-specific autonomous vehicle personal preferences including, for example, controlling the music, or adjusting the temperature and air conditioning.

The user's request for an autonomous vehicle, along with other user-specified criteria, is communicated to the autonomous vehicle 10 via network 30, which can be any known form of wireless electronic communication including cellular, the internet, wide area network, local area network, Bluetooth, Ultra Wide Band (UWB), Near-Field Communication (NFC), etc.

In step 108, the autonomous vehicle 10 arrives at a pickup location based on the received user's request and waits for the user to arrive.

In optional step 110, the autonomous vehicle 10 may indicate to the user that it is either arriving or has already arrived at the pickup location by communicating with the user's mobile device 20 to provide the user with a notification that their vehicle has arrived and is waiting for them at the pickup location. In a further embodiment to further guide the user, a map may be displayed on the user's mobile device showing the user's current location and the autonomous devices' pickup location, and which can be continually updated in real-time.

In step 120, the system generates a signal, referred to herein as a “cue”, to help the user identify which autonomous vehicle is reserved for them and may also provide local wayfinding to guide both the user and the autonomous vehicle to a safe and effective pickup location. Without a human driver, an autonomous vehicle relies more heavily on communications passing between the autonomous vehicle and the user's mobile device. The system may utilize any of a wide range of communication forms and protocols known in the art.

Importantly, the system functions to communicate with and guide the user to the pickup location and then provide an intuitive way for the user to identify their reserved autonomous vehicle. A large group of autonomous vehicles, for example, at an airport or after a large sporting event, would all likely appear indistinguishable from each other to most users. To aid the user in finding their taxi amongst an indistinguishable mass of autonomous vehicles, the system can produce cues in the form of a visual indicator and/or an audible signal and/or a vibration so that a user can quickly determine which autonomous vehicle they have reserved. In large group scenarios, the system guides individual users directly to their autonomous vehicle, but a preferred system would also aim to minimize interference and cross-talk that could mistakenly lead a user to an autonomous vehicle intended for somebody else.

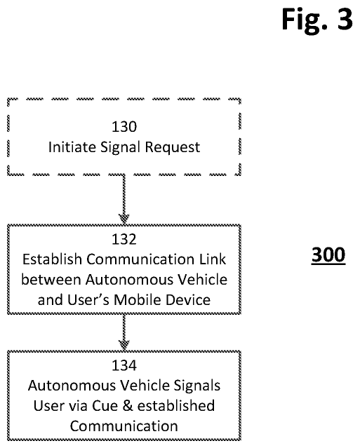

Referring now to FIG. 3, one embodiment of step 120, that is, the autonomous vehicle signaling the user to the autonomous vehicle, will now be described. The user may approach the pickup location where the autonomous vehicle is waiting for them. Upon arriving, however, a user may realize that in addition to their autonomous vehicle, there are a number of other similar looking autonomous vehicles waiting for their passengers.

A user may then be lost or confused as to which of these autonomous vehicles is the one reserved for them. In an optional step 130, the user may then initiate a signaling request by pressing a button on the user interface on their mobile phone, e.g., via mobile device application 22 on mobile device 20. Alternatively, such a signaling request can be performed automatically by the user's mobile device without requiring user initiation or action.

At step 132, in response to the user initiating a signaling request, or based on some other factor such as time or proximity between the autonomous vehicle and mobile device, a communications connection is established between the mobile application 22 on the user's mobile device 20 and the autonomous vehicle application 12 on the autonomous vehicle 10. This communications connection operates across network 30 and may use the same form of wireless electronic communication as the earlier described steps or may use a different form of wireless electronic communication including any possible form of peer-to-peer communication between the user's mobile device and the autonomous vehicle presently known or later developed.

Once the communication connection has been established between the autonomous vehicle and the user's mobile device, at step 134, the autonomous vehicle may generate visual or audible cues to signal or direct the user's attention to their vehicle. Visual cues may include flashing headlights, flashing turn signal indicators, flashing hazard lights, and/or interior lights of the autonomous vehicle. Audible cues such as honking the autonomous vehicle's horn may also be used. Any such cues are provided by signal means 14 of autonomous vehicle 10.

Further at step 134, the autonomous vehicle may also have those visual or audible cues be communicated to the user's mobile device. In one embodiment, using the communications connection established between the autonomous vehicle and the mobile device, the system can direct the mobile device to generate a corresponding cue that duplicates the pattern of visual or audible cues that the autonomous vehicle is signaling. For example, the autonomous vehicle may flash its headlights twice as an indicator to the user. The user's mobile device, in this case, would also be directed via the mobile device application to flash its screen or LEDs, mimicking the autonomous vehicle's pattern. Any such cues on the user's mobile device are provided by signal means 24 of the user's mobile device 20.

It is to be understood, in light of the teachings herein, that a reference to a user can, in some embodiments, refer to more than one user. For example, a user may request an autonomous vehicle for themselves as described herein. Alternatively, a user may request an autonomous vehicle for another user, in which case the operations and functionality described herein would be split between the user who made the request and the other user for whom the autonomous vehicle was requested, but would otherwise be performed in essentially the same manner as described for a single user requesting an autonomous vehicle for themselves.

In one embodiment, the mobile device and the autonomous vehicle's cues may be temporally aligned or synchronized to aid the user in identifying the autonomous vehicle. Since the lights on the user's mobile device flash at the same moments the autonomous vehicle's lights are flashing and/or in the same pattern, the user can quickly identify the vehicle intended for them.

In another embodiment, the mobile device and autonomous vehicle's cues may instead be in the form of a call and response. In this embodiment, for example, the autonomous vehicle, via the autonomous vehicle application and signaling means, may flash its lights for example, three times in a row. The system, via the mobile device application, signaling means, and the established communication connection, then will cause the user's mobile device to respond to the autonomous vehicles cues by duplicating them. As an example, the autonomous vehicle may flash its lights three times in a row and afterwards, the user's mobile device may flash its lights three times in a row, appearing as a response to the autonomous vehicle's call.

In a further embodiment of the system, the interface on the mobile device application on the user's mobile device may also be used to call for the indicator again, or to have it repeat multiple times. In a yet further embodiment of the system, the interface on the mobile device application on the user's mobile device may also provide a list of possible cue patterns from which the user can select and, once selected, then the user can experience a different cue thereby confirming they are being directed to the correct autonomous vehicle.

In a still further embodiment, the frequency and/or intensity of the cue may change based on the proximity between the user's mobile device and the autonomous vehicle (e.g., the cue may increase as the user's mobile device gets closer to the autonomous vehicle and may decrease as they get further from each other). Such a proximity determination can be made by the system using various means including UWB and/or Bluetooth signal strength.

In another embodiment, the types and complexity of the patterns of visual and audible cues may either change or increase if the autonomous vehicle application determines that there are other nearby autonomous vehicles waiting for passengers. When there are many users waiting or searching for their autonomous vehicle, the series of flashing lights and audible cues from all the vehicles could be overwhelming and confusing for users. Therefore, in this further embodiment, the autonomous vehicles may detect other nearby autonomous vehicles and communicate with each other to ensure that each vehicle's indications are not occurring simultaneously with another.

In another embodiment, the autonomous vehicle may use audible cues such as the car horn for one user, while another autonomous vehicle may use lights. The interface on the mobile device application on the user's mobile device may also communicate to the user what types of indicators they should be expecting and detail how to use those indicators to identify their autonomous vehicle.

In yet another embodiment, the system via the mobile device application may cause the user's mobile device to provide a tactile cue, such as vibrate, rather than flash lights or provide audible sounds. Vibration of the user's mobile device may be a preferred cue because the user may be able to feel and identify the vibrational patterns all while their mobile device remains in their pocket and without having to look at the mobile device to recognize the cue as matching that of the autonomous vehicle they are observing.

It is to be understood that while the primary example described herein is that of an autonomous vehicle operating as a taxi for a user, the system and method described herein is equally applicable to any autonomous vehicle, including cars, trucks, boats, carts, robots, etc., and to any mobile device, including smart phones, tablets, computers, smart watches, wearables, handheld devices, etc., for the transportation and/or delivery of any thing, including a user, goods, services, etc.

In a still further embodiment, it should be appreciated that either or both of the autonomous vehicle application and the mobile device application can be preloaded into the autonomous vehicle and mobile device, respectively, or may be integrated into existing software and/or hardware of the autonomous vehicle and/or mobile device, including any existing operating system included therein.

It should also be appreciated that the described method and apparatus can be implemented in numerous ways, including as a process, an apparatus, or a system. The methods described herein may be implemented by program instructions for instructing a processor to perform such methods, and such instructions recorded on a non-transitory computer readable storage medium such as a hard disk drive, floppy disk, optical disc such as a compact disc (CD) or digital versatile disc (DVD), flash memory, etc., or via a computer network wherein the program instructions are sent over optical or electronic communication links. Such program instructions may be executed by means of a processor or controller, or may be incorporated into fixed logic elements. It should be noted that the order of the steps of the methods described herein may be altered and still be within the scope of the disclosure.

These and other variations upon the embodiments are intended to be covered by the present disclosure, which is limited only by the appended claims.

What is claimed is:

1. A method for wireless interaction between a mobile device and an autonomous vehicle comprising:
receiving a request for the autonomous vehicle from a mobile device across an electronic network;
establishing an electronic communication connection between the autonomous vehicle and the mobile device once the autonomous vehicle has arrived at an autonomous vehicle pickup location;
generating an autonomous vehicle cue by the autonomous vehicle once the electronic communication connection has been established; and,
directing the mobile device, via the electronic communication connection, to generate a mobile device cue corresponding to the autonomous vehicle cue.

2. The method of claim 1 wherein the autonomous vehicle cue is a visual or audible cue.

3. The method of claim 1 wherein the mobile device cue is a visual or audible, or tactile cue.

4. The method of claim 1 wherein the mobile device cue duplicates a pattern of the autonomous vehicle cue.

5. The method of claim 1 wherein the autonomous vehicle cue and the mobile device cue operate in the form of a call and response.

6. The method of claim 1 further comprising the autonomous vehicle determining that there are other autonomous vehicles nearby and changing or increasing the autonomous vehicle cue.

7. The method of claim 1 wherein a frequency and/or intensity of the mobile device cue changes based on a proximity between the mobile device and the autonomous vehicle.

8. A system for wireless interaction between a mobile device and an autonomous vehicle comprising:
a mobile device configured to generate a request for the autonomous vehicle across an electronic network;
an autonomous vehicle configured to receive the request for the autonomous vehicle from the mobile device across the electronic network;
the autonomous vehicle configured to establish an electronic communication connection between the autonomous vehicle and the mobile device once the autonomous vehicle has arrived at an autonomous vehicle pickup location;
the autonomous vehicle configured to generate an autonomous vehicle cue by the autonomous vehicle once the electronic communication connection has been established;
the autonomous vehicle configured to direct, via the electronic communication connection, the mobile device to generate a mobile device cue corresponding to the autonomous vehicle cue; and,
the mobile device configured to generate the directed mobile device cue.

9. The system of claim 8 wherein the autonomous vehicle cue is a visual or audible cue.

10. The system of claim 8 wherein the mobile device cue is a visual or audible, or tactile cue.

11. The system of claim 8 wherein the mobile device cue duplicates a pattern of the autonomous vehicle cue.

12. The system of claim 8 wherein the autonomous vehicle cue and the mobile device cue are configured to operate in the form of a call and response.

13. The system of claim 8 wherein the autonomous vehicle is further configured to determine that there are other autonomous vehicles nearby and change or increase the autonomous vehicle cue.

14. The system of claim 8 wherein a frequency and/or intensity of the mobile device cue is configured to change based on a proximity between the mobile device and the autonomous vehicle.
